(19) United States
(12) Patent Application Publication
(10) Pub. No.: US 2011/0019105 A1
(43) Pub. Date: Jan. 27, 2011

(54) VERIFICATION OF SYMBOLS RECEIVED THROUGH A TOUCHPAD OF A REMOTE CONTROL DEVICE IN AN ELECTRONIC SYSTEM TO ALLOW ACCESS TO SYSTEM FUNCTIONS

(75) Inventor: Jarrod C. Austin, Parker, CO (US)

Correspondence Address: SETTER ROCHE LLP, PO BOX 780, ERIE, CO, 80516, US

(73) Assignee: EchoStar Technologies L.L.C., Englewood, CO (US)

(21) Appl. No.: 12/509,552

(22) Filed: Jul. 27, 2009

(51) Int. Cl. H04N 5/44; G06F 3/041; G05B 19/02

(52) U.S. Cl. 348/734; 178/18.03; 340/825.22; 348/E05.096

(57) ABSTRACT

An electronic system comprises an electronic device and an associated remote control device having a touchpad. The electronic system receives verification data that corresponds to a first user input of a verification symbol. The electronic system receives a second user input through the touchpad, and in response, generates user data that corresponds to the second user input. The electronic system compares the verification data to the user data to determine if a matching relationship exists between the verification data and the user data. The electronic system provides access to a function if the matching relationship exists, and denies access to the function if the matching relationship does not exist. In some examples, the electronic system receives the first user input of the verification symbol through the touchpad, and in response, generates the verification data that corresponds to the first user input. In some examples, the electronic system is a video system.

### BACKGROUND

Consumer electronic devices, such as televisions, set-top boxes, and audio receivers continue to enjoy wide popularity with users. Remote control devices are typically provided with these electronic devices to allow the users to control their electronic devices from beyond arm's length. The remote control devices typically include keys that allow the user to input information to remotely control their electronic devices by requesting functions. In some cases, the requested control function is restricted and requires the input of an access code. For example, access to the parental control in a television system is usually protected by an access code.

A touchpad has a contact-sensitive surface that can sense the touch of a finger or stylus and provide electronic data that identifies the location, timing, and pressure of the touch. Many laptop computers and other like devices now include a touchpad for user inputs—typically to allow the user to move a cursor or select an option. The remote control devices mentioned above are now being equipped with a touchpad to allow users to move a cursor or select an option—typically in conjunction with a display on the electronic device.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a simplified block diagram of an electronic system including an electronic device and an associated remote control device having a touchpad according to an embodiment of the invention.

FIG. 2 is a flow diagram of a method of operating an electronic system including an electronic device and an associated remote control device having a touchpad according to an embodiment of the invention.

FIG. 3 is a block diagram of a remote control device according to an embodiment of the invention.

FIG. 4 is a block diagram of an electronic device according to an embodiment of the invention.

FIG. 5 is a block diagram of a satellite video system according to an embodiment of the invention.

FIG. 6 is a sketch of a remote control device for a satellite video system according to an embodiment of the invention.

FIGS. 7A and 7B are sketches of symbols on a remote control touchpad according to an embodiment of the invention.

FIG. 8 is a flow diagram of a method of operating a satellite video system including a set-top box and an associated remote control device having a touchpad according to an embodiment of the invention.

FIGS. 9A and 9B are time-sequence diagrams that illustrate user inputs of a series of symbol components that comprise a symbol.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

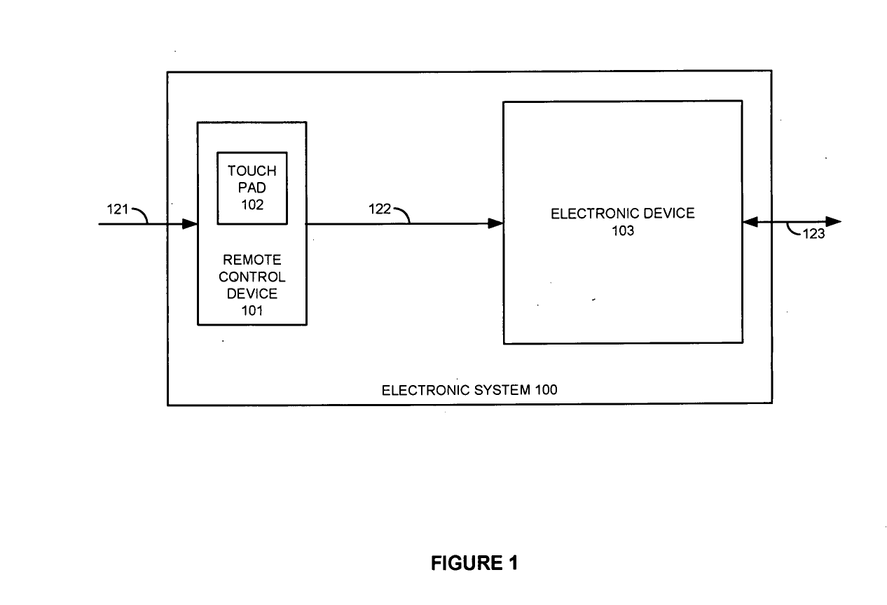

FIG. 1 illustrates electronic system 100. Electronic system 100 could be an audio/video system, data processing system, machine system, or some other system comprising electronic devices. Electronic system 100 comprises remote control device 101 and electronic device 103. Remote control device 101 is associated with electronic device 103 and includes touchpad 102.

Remote control device 101 receives user input 121—possibly through touchpad 102. Remote control device 101 converts user input 121 into corresponding user data 122 and transfers user data 122 to electronic device 103. Electronic device 103 processes user data 122 to perform various functions. Some of these functions are restricted and first require the user to perform a successful symbol verification operation. Although not required, electronic device 103 may also exchange signals 123 with other electronic systems.

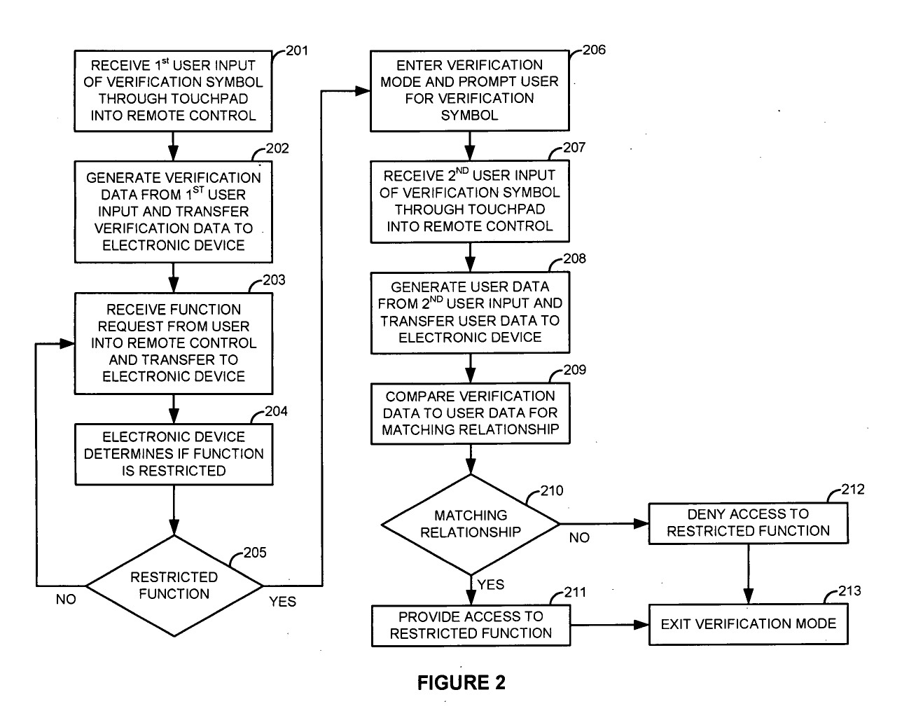

FIG. 2 illustrates the operation of electronic system 100. Remote control device 101 receives a first user input of a verification symbol through touchpad 102 (201). The verification symbol could be a signature, initials, alphanumeric set, diagram, or some other graphical user input through touchpad 102. Remote control device 101 generates verification data that corresponds to the first user input and transfers the verification data to electronic device 103 (202).

Subsequently, remote control device 101 receives a user request for a function of electronic system 100 (203). The function could be a system configuration, parental control, financial transaction, service access, or some other system process. Remote control device 101 transfers the user request for the function to electronic device 103 (203). Electronic device 103 determines if the request is for a restricted function (204). If the requested function is not restricted (205), then remote control device 101 again awaits a function request (203), and although not shown, electronic device 103 initiates the unrestricted function. If the requested function is restricted (205), electronic device 103 enters a verification mode and drives a display of a prompt for a second user input of the verification symbol (206).

Responsive to the user prompt, remote control device 101 receives a second user input of the verification symbol through touchpad 102 (207). Remote control device 101 generates user data that corresponds to the second user input and transfers the user data to electronic device 103 (208). Electronic device 103 compares the verification data to the user data to determine if a matching relationship exists between the verification data and the user data (209). The matching relationship exists if the two verification symbols resulting from the first and second user inputs are substantially similar. A two-dimensional pattern matching technique could be used to perform this comparison.

If the matching relationship exists (210), then electronic system 103 provides access to the restricted function (211). If the matching relationship does not exist (210), then electronic system 103 denies access to the restricted function—although a few more verification attempts may be offered (212). After the verification operation, electronic device 103 exits the verification mode (213), and as a result, electronic system 103 will not process additional user data from touchpad 102 for verification purposes until the verification mode is re-entered.

There can be variations to the above operation. Some of the processing operations performed above by electronic device 103 could be performed by remote control device 101. For example, remote control device 101 may store the verification data and perform verification comparison in response to an instruction from electronic system 103. In another variation, another electronic system with another touchpad might obtain and transfer the verification data to remote control device 101 or electronic device 103. Likewise, if electronic system 100 obtains the verification data, remote control device 101 or electronic device 103 might transfer the verification data to another electronic system. Some aspects of the operation could be omitted. For example, the use of the prompt and the verification mode could be omitted.

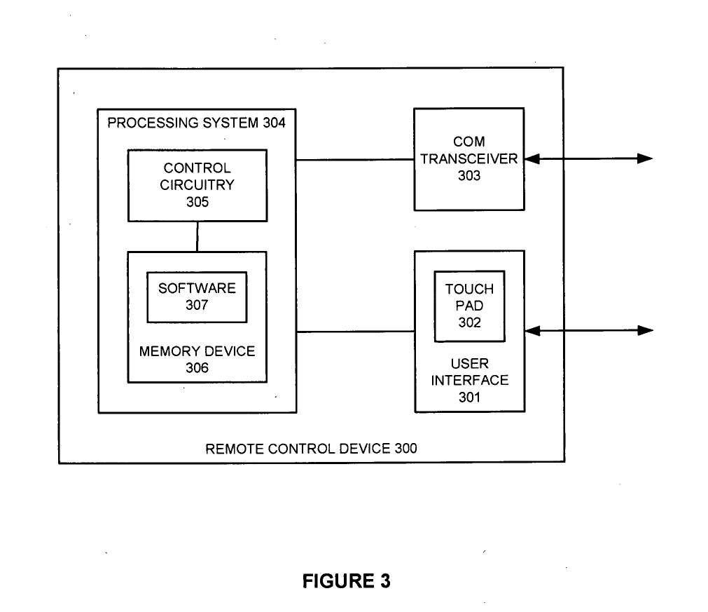

FIG. 3 illustrates remote control device 300. Remote control device 300 is an example of remote control device 101, although remote control device 101 could use alternative configurations. Remote control device 300 exerts control over a set-top box, video game console, audio system, Internet appliance, or some other media device—including combinations thereof.

Remote control device 300 comprises user interface 301, communication transceiver 303, and processing system 304. User interface 301 includes touchpad 302. Processing system 304 is linked to user interface 301 and communication transceiver 303. Processing system 304 includes control circuitry 305 and memory device 306 that stores operating software 307. Remote control device 300 may include other well-known components such as a battery and an enclosure that are not shown for clarity.

User interface 301 comprises components that interact with a user to receive user inputs and present information to the user. User interface 302 includes touchpad 302 and may also include switches, keys, lights, or some other user input/output apparatus—including combinations thereof. Touchpad 302 includes a capacitive touch surface and processing circuitry. The capacitive touch surface is allocated into an X-Y grid. The touch of a finger at a point on the grid creates capacitance at that point on the grid. The processing circuitry processes signals resulting from the capacitance to identify the X-Y coordinates corresponding to touched locations. The processing circuitry may also process the signals to time stamp the coordinates and to determine the associated pressure of the touch. Based on the timing and motion of the touch sequence, the processing circuitry can also distinguish touches between taps and scrolls.

Communication transceiver 303 comprises Radio Frequency (RF) communication circuitry and an antenna. The RF communication circuitry typically includes an amplifier, filter, RF modulator, and signal processing circuitry. Communication transceiver 303 may also include a memory device, software, processing circuitry, or some other communication device. Communication transceiver 303 may use IEEE 802.15.1, IEEE 802.15.4, or some other wireless communication format. In alternative configurations, infrared communications may be used instead of RF communications. Communication transceiver 303 transfers messages to the controlled device that indicate user inputs, including inputs through touchpad 302.

Processing circuitry 304 comprises microprocessor, power circuitry, communication lines, and other circuitry. The microprocessor circuitry retrieves and executes operating software 307 from memory device 306. Memory device 306 comprises a flash drive, data storage circuitry, or some other memory apparatus. Processing circuitry 304 is typically mounted on a circuit board that may also hold memory device 306 and portions of user interface 301 and communication transceiver 303.

Operating software 307 comprises computer programs, firmware, or some other form of machine-readable processing instructions. Operating software 307 may include an operating system, utilities, drivers, network interfaces, applications, or some other type of software. When executed by control circuitry 305, operating software 307 directs processing system 304 to operate remote control device 300 as described herein. In particular, operating software 307 directs processing system 304 to process touchpad inputs to support symbol verification as described herein.

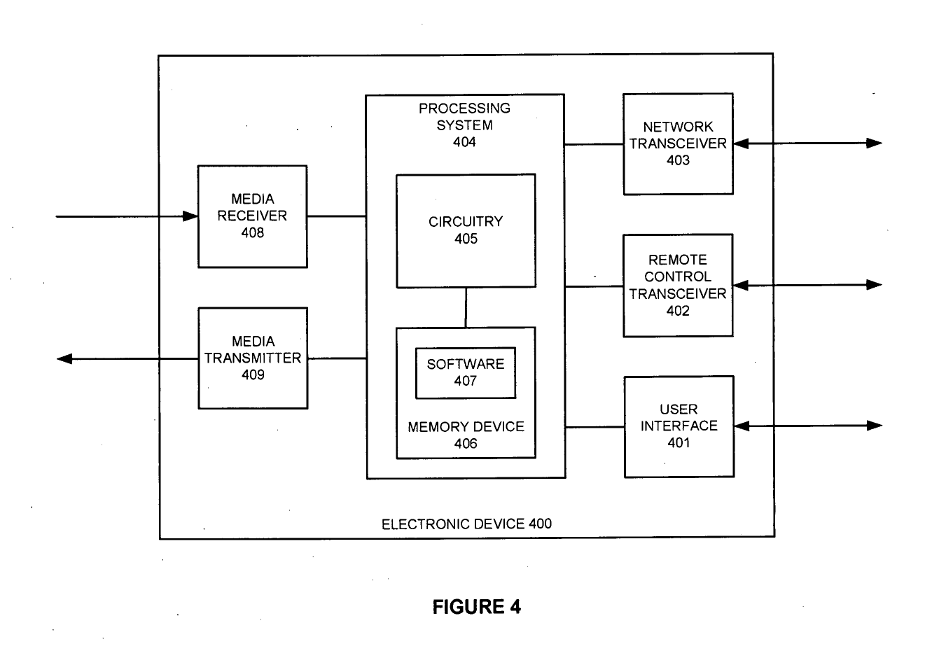

FIG. 4 illustrates electronic device 400. Electronic device 400 is an example of electronic device 103, although electronic device 103 may use alternative configurations. Electronic device 400 could be a set-top box, video game console, audio system, Internet appliance, or some other media device—including combinations thereof. Electronic device 400 comprises user interface 401, remote control transceiver 402, network transceiver 403, processing system 404, media receiver 408, and media transmitter 409. Processing system 404 is linked to components 401-403 and 408-409. Processing system 404 includes circuitry 405 and memory device 406 that stores operating software 407.

User interface 401 comprises components that interact with a user. User interface 402 may include keys, lights, display, dials, or some other user input/output apparatus.

Remote control transceiver 402 comprises Radio Frequency (RF) communication circuitry and an antenna. The RF communication circuitry typically includes an amplifier, filter, RF modulator, and signal processing circuitry. Remote control transceiver 402 may also include a memory device, software, processing circuitry, or some other communication device. Remote control transceiver 402 may use IEEE 802.15.1, IEEE 802.15.4, or some other wireless communication format. In alternative configurations, infrared communications may be used instead of RF communications. Remote control transceiver 402 receives messages indicating user inputs from the remote control device as described herein.

Network transceiver 403 comprises circuitry and interface components that communicate over a communication network, such as a telephone network, internet-protocol network, Ethernet network, wireless network, or the like.

Media receiver 408 comprises circuitry and interface components that receive media from a satellite antenna, cable television feed, optical fiber link, Internet interface, or some other media transmission system. Examples of media include video, audio, Internet traffic, images, or some other media content. Media receiver 408 and network transceiver 403 could be integrated together in some examples. Media transmitter 409 comprises circuitry and interface components that transfer media to a media presentation system, such as a television, computer, audio system, media player, or the like. Media transmitter 409 and media receiver 408 could be integrated together in some examples.

Circuitry 405 comprises microprocessors, power circuitry, communication lines, and other circuitry, such as digital signal processors and digital video recorder circuitry. Circuitry 405 is typically mounted on one or more circuit boards that may also hold memory device 406 and portions of communication components 401-403 and 408-409. Circuitry 405 retrieves and executes operating software 407 from memory device 406. Memory device 406 comprises a disk drive, flash drive, data storage circuitry, and/or some other memory apparatus. Operating software 407 comprises computer programs, firmware, or some other form of machine-readable processing instructions. Operating software 407 may include an operating system, utilities, drivers, network interfaces, applications, or some other type of software. When executed by circuitry 405, operating software 407 directs processing system 404 to operate electronic device 400 as described herein. In particular, operating software 407 directs processing system 404 to perform validation on data from touchpad inputs as described herein.

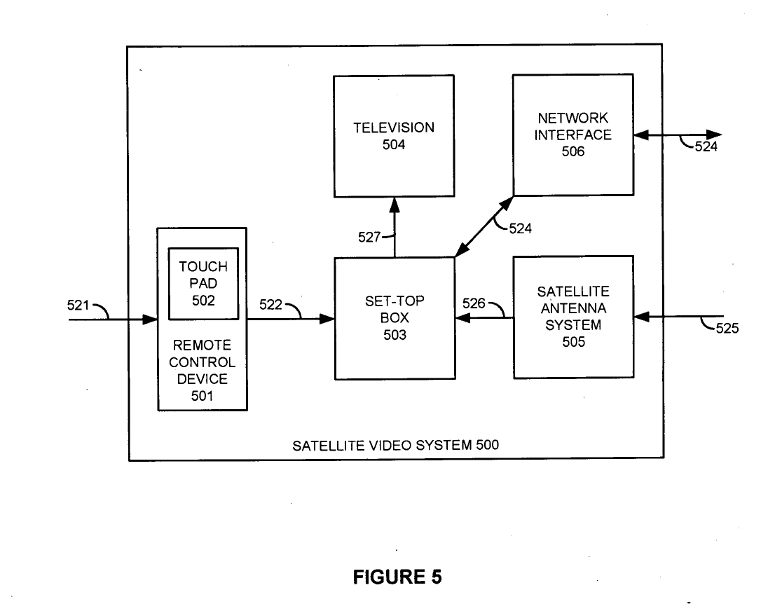

FIG. 5 illustrates satellite video system 500. Remote control device 501 is an example of remote control devices 101 and 300, although these devices may have alternative configurations. Set-top box 503 is an example of electronic devices 103 and 400, although these devices may have alternative configurations. Satellite video system 500 comprises remote control device 501, set-top box 503, television 504, satellite antenna system 505, and network interface 506.

Satellite antenna system 505 receives video and other information from a satellite in satellite signal 525 and transfers the video and other information in electronic signal 526 to set-top box 503. Set-top box 503 transfers the video and some of the information in electronic signal 527 to television 504. Television 504 displays the video to the user. Network interface 506 (and a communication network) exchange data 524 between set-top box 503 and the satellite video provider.

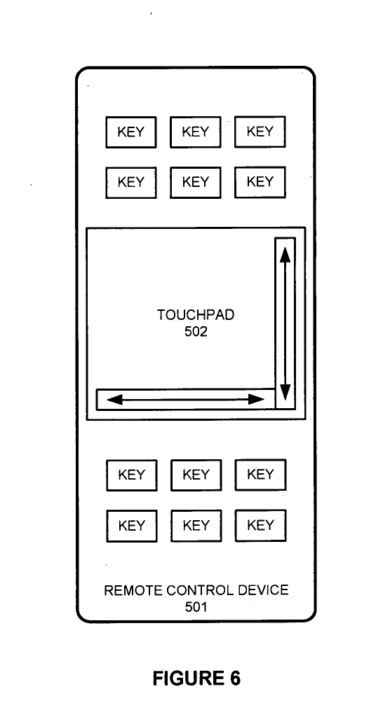

FIG. 6 illustrates remote control device 501 having touchpad 502. Remote control device 501 is a handheld device. Remote control device 501 has control keys for power on/off, channel up/down, volume up/down, program guide, directional arrows up/down/right/left, play, reverse, fast forward, and the like. Touchpad 502 can emulate several of these keys when combined with a graphic display. For example, the user may trace their finger up touchpad 502 to emulate a channel up command. Note that touchpad 502 has a vertical scroll bar and a horizontal scroll bar.

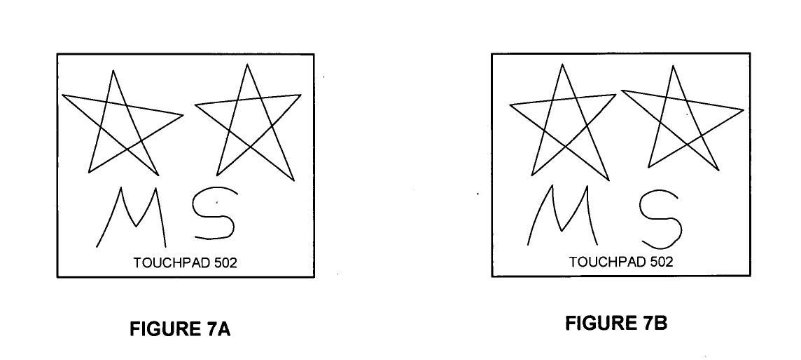

FIG. 7A illustrates a verification symbol from a first user input through touchpad 502. FIG. 7B illustrates a verification symbol from a second user input through touchpad 502. These symbols are used in the following discussion of satellite video system 500.

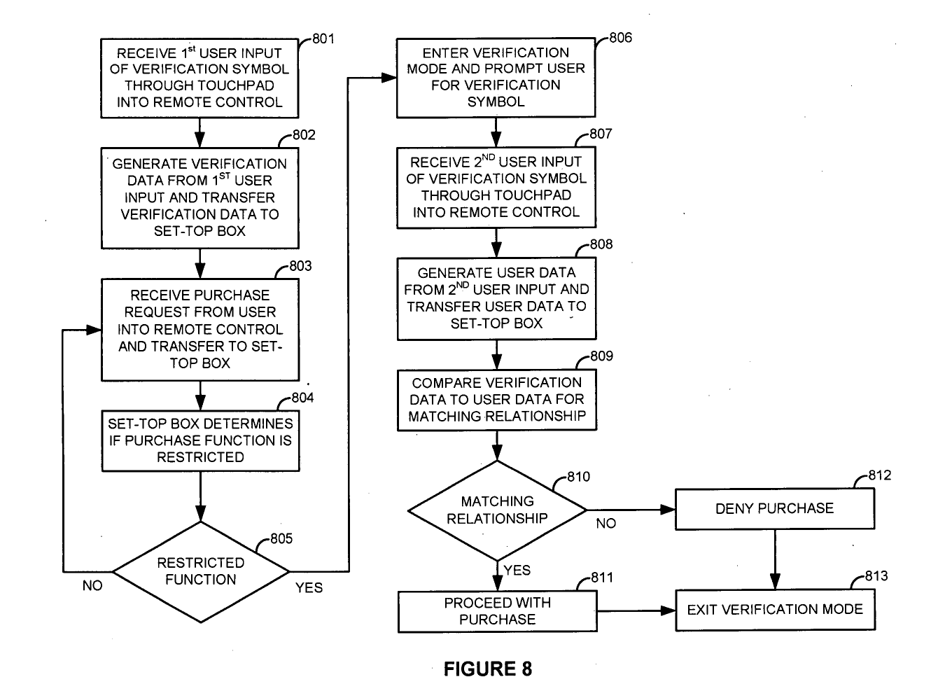

FIG. 8 illustrates the operation of remote control device 501 and set-top box 503. Remote control device 501 receives a first user input of a verification symbol through touchpad 502 (801). The first user input is illustrated on FIG. 7A. Remote control device 501 generates verification data that indicates the X-Y coordinates and timing for the first user input and transfers the verification data to set-top box 503 (802). Set-top box 503 typically drives a contemporaneous display of the first user input on television 504, so the user can view the verification symbol as they input it through touchpad 502. Set-top box 503 stores the verification data for future verification operations.

Subsequently, remote control device 501 receives a user request for a purchase from satellite video system 500 and transfers the purchase request to set-top box 503 (803). Set-top box 503 determines if the purchase request is for a restricted function (804). If the purchase function is not restricted (805), then the remote control device 501 again awaits a function request (803), and although not shown, set-top box 503 initiates the purchase. If the purchase function is restricted (805), set-top box 503 enters a verification mode and transfers a video signal to television 504 to display of a prompt for a second user input of the verification symbol (806).

Restricted functions for satellite video system 500 might include: purchases, parental controls, changes to personal settings (viewing preferences, favorite channels, show list), installer activation, and general security that is restricted to certain individuals. In this example, purchases are restricted, so the verification mode is entered and the user prompt is provided (806). Responsive to the user prompt, remote control device 801 receives a second user input of the verification symbol through touchpad 502 (807). The second user input is illustrated on FIG. 7B. Remote control device 501 generates user data that indicates the X-Y coordinates and timing for the second user input and transfers the user data to set-top box 503 (808). Set-top box 503 typically drives a contemporaneous display of the second user input on television 504, so the user can view the verification symbol as they input it through touchpad 502.

Set-top box 503 compares the verification data to the user data to determine if a matching relationship exists between the two verification symbols (809). A two-dimensional pattern matching technique could be used to compare the two verification symbols. These pattern matching techniques typically allocate the space containing the verification symbols into a grid and identify the grid points that include portions of the verification symbols. The grid points from a symbol are processed to assess their spatial relation to each other. In other words, where is each grid point relative to the other grid points in the same symbol. The grid points from one symbol are also processed to assess their spatial relation to the grid points in the other symbol. For two grid points from different symbols to have a matching relationship, the two grid points should generally correspond to each other in a spatial manner. In addition, the two grid points should have similar spatial relationships to the other grid points in their own symbol. When two symbols have a threshold amount of grid points with matching relationships, then the two symbols have a matching relationship. Even though the symbols on FIGS. 7A and 7B are not identical from an overlay perspective, they are similar from a pattern matching perspective, so the matching relationship exists.

Timing information could also be considered to assess a matching relationship. For example, the grid points described above could be time-stamped at input. The time stamps could be assessed in a similar manner to the spatial relationships described above. The grid points from a symbol are processed to assess their timing relation to each other. In other words, when was each grid point generated relative to when the other grid points in the same symbol were generated. The grid points in one symbol are also processed to assess their timing relation to the grid points in the other symbol. For two grid points from different symbols to have a matching relationship, the two grid points should generally share similar timing relationships to the other grid points in their own symbol. The overall input speed for the two symbols (or symbol segments) could also be compared for similarity.

If the matching relationship exists (810), then set-top box 503 proceeds with the purchase (811). If the matching relationship does not exist (810), then set-top box 503 denies the purchase—although a few more verification attempts may be offered (812). In this example, the matching relationship exists (810), so set-top box 503 proceeds with the purchase (811). After the verification operation, set-top box 503 exits the verification mode (813), and as a result, set-top box 503 will not process additional user data from touchpad 502 for verification purposes until the verification mode is re-entered.

Consider the following example where a technician from the satellite video provider is configuring satellite video system 500 for the user. The technician may travel to several user sites in a given day to install or configure several video systems. In this situation, the technician's verification symbol could be provided to set-top box 503 in data 524. The technician may then access restricted configuration functions that are not available to general users. This process could be repeated at the other user sites.

In some variations, the input of the verification symbol can be made through a series of discrete user inputs during a series of discrete time intervals. For example, the verification symbol could comprise a series of letters, numbers, and/or diagrams. The first component of the series is input through the touchpad during a first time interval, the second component of the series is input through the touchpad during a second time interval, and so on until the series of inputs is complete. Visual prompts from a display could be used to guide the user from one time interval to the next to complete the input process.

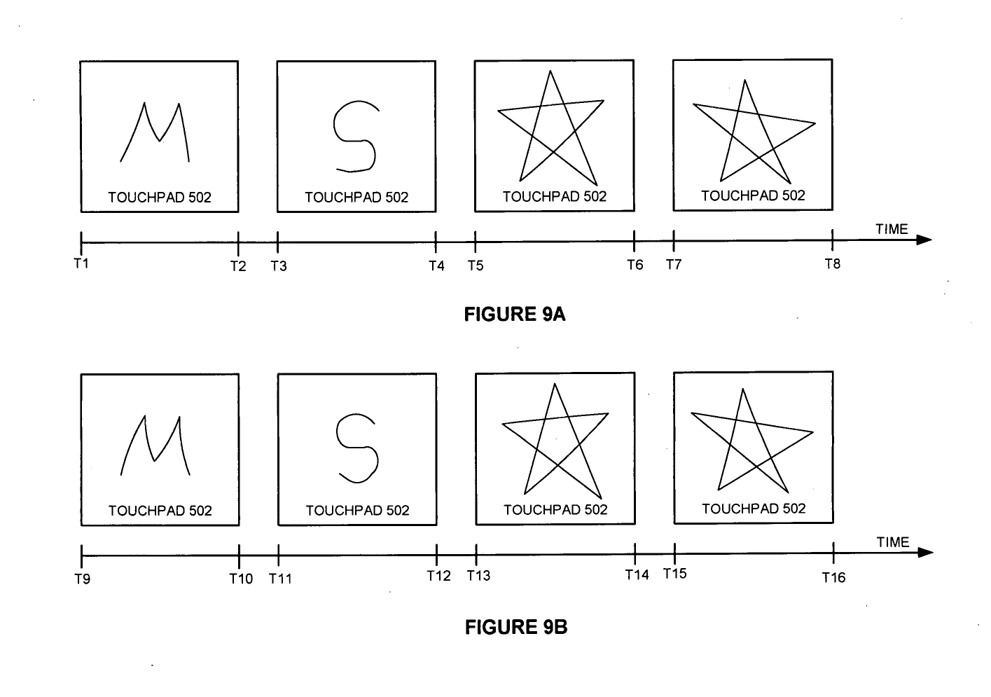

FIGS. 9A and 9B illustrate the above-described variation with respect to satellite video system 500. FIG. 9A shows the first series input of a symbol through touchpad 502 comprising the series M S * * where the component M is input between time T1 and T2, S is input between time T3 and T4, the first * is input between time T5 and T6, and the second * is input between time T7 and T8. Set-top box 503 receives data from remote control device 501 indicating each user input and drives television 504 to contemporaneously display each component of the series as it is being input. In between each component input (times T2-T3, T4-T5, and T6-T7), set-top box 503 drives television 504 to display a prompt for the next component of the series.

FIG. 9B shows the second series input of the symbol through touchpad 502 comprising the series M S * * where the verification operation has now been invoked. Note that there would typically be a large time gap between times T8 and T9. The component M is input between time T9 and T10, S is input between time T11 and T12, the first * is input between time T13 and T14, and the second * is input between time T15 and T16. Set-top box 503 receives data from remote control device 501 indicating each user input and drives television 504 to contemporaneously display each component of the series as it is being input. In between each input (times T10-T11, T12-T13, and T14-T15), set-top box 503 drives television 504 to display a prompt for the next component of the series.

To assess a matching relationship, the same analysis described above is undertaken on a symbol component-by-symbol component basis. For example, the symbol component from time T1-T2 is compared to the symbol component from time T9-10. Likewise, the symbol component from time T3-T4 is compared to the symbol component from time T11-12, the symbol component from time T5-T6 is compared to the symbol component from time T13-14, and the symbol component from time T7-T8 is compared to the symbol component from time T15-T16. If each symbol component has a matching relationship, then the symbol comprising the series of symbol components also has a matching relationship.

While several embodiments of the invention have been discussed herein, other implementations encompassed by the scope of the invention are possible. For example, while various embodiments have been described within the context of a television set-top box, other electronic devices capable of being controlled by way of a wireless remote control device, including, but not limited to, televisions, audio receivers, gaming consoles, DVRs, CD and DVD players, and computers, may benefit from application of the concepts explicated above. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A method of operating an electronic system comprising an electronic device and an associated remote control device having a touchpad, the method comprising:
in the electronic system, receiving verification data that corresponds to a first user input of a verification symbol;
in the electronic system, receiving a second user input through the touchpad of the remote control device, and in response, generating user data that corresponds to the second user input;
in the electronic system, comparing the verification data to the user data to determine if a matching relationship exists between the verification data and the user data;
in the electronic system, providing access to a function of the electronic system if the matching relationship exists, and denying access to the function of the electronic system if the matching relationship does not exist.

2. The method of claim 1 wherein receiving the verification data comprises receiving the first user input of the verification symbol through the touchpad of the remote control device, and in response, generating the verification data that corresponds to the first user input.

3. The method of claim 1 wherein the first user input of the verification symbol is through another electronic system and receiving the verification data comprises receiving the verification data transmitted from the other electronic system.

4. The method of claim 1 wherein generating the verification data and generating the user data comprises generating the verification data and generating the user data in the remote control device, and further comprising, transferring the verification data from the remote control device to the electronic system and transferring the user data from the remote control device to the electronic system.

5. The method of claim 1 further comprising, in the electronic device, driving a display of a prompt for the second user input in response to a user request for the function.

6. The method of claim 1 further comprising, in the electronic system, entering a verification mode in response to a user request for the function and subsequently exiting the verification mode, and wherein comparing the verification data to the user data to determine if the matching relationship exists comprises comparing the verification data to the user data to determine if the matching relationship exists only if the second user input is received during the verification mode.

7. The method of claim 1 wherein receiving the second user input through the touchpad comprises receiving a series of discrete inputs during a series of discrete time intervals.

8. The method of claim 1 wherein the verification data indicates a first timing information for the first user input and the user data indicates a second timing information for the second user input and comparing the verification data to the user data to determine if the matching relationship exists comprises processing the first timing information and the second timing information to perform time correlation.

9. The method of claim 1 wherein the symbol comprises a diagram.

10. The method of claim 1 wherein the electronic system comprises a video system and the electronic device comprises a video processing device.

11. An electronic system comprising:
an electronic device configured to receive verification data that corresponds to a first user input of a verification symbol;
a remote control device associated with the electronic device and having a touchpad, the remote control device configured to receive a second user input through the touchpad, and in response, generate user data that corresponds to the second user input and transfer the user data; and
the electronic device further configured to receive the user data, compare the verification data to the user data to determine if a matching relationship exists between the verification data and the user data, provide access to a function of the electronic system if the matching relationship exists, and deny access to the function of the electronic system if the matching relationship does not exist.

12. The electronic system of claim 11 wherein the remote control device is configured to receive the first user input of the verification symbol through the touchpad, and in response, generate the verification data that corresponds to the first user input and transfer the verification data.

13. The electronic system of claim 11 wherein the first user input of the verification symbol is through another electronic system and the electronic device is configured to receive the verification data transmitted from the other electronic system.

14. The electronic system of claim 11 wherein the electronic device is configured to transfer the verification data for receipt by another electronic system.

15. The electronic system of claim 11 wherein the electronic device is further configured to drive a display of a prompt for the second user input in response to a user request for the function.

16. The electronic system of claim 11 wherein:
the electronic device is configured to enter a verification mode in response to a user request for the function and subsequently exit the verification mode; and
the electronic device is configured to compare the verification data to the user data to determine if the matching relationship exists only if the second user input is received during the verification mode.

17. The electronic system of claim 11 wherein the remote control device is configured to receive the second user input through the touchpad in a series of discrete user inputs during a series of discrete time intervals.

18. The electronic system of claim 11 wherein:
the verification data indicates first timing information for the first user input;
the remote control is configured to determine second timing information for the second user input and indicate second timing information in the user data; and
the electronic device is configured to process the first timing information and the second timing information to perform time correlation.

19. The electronic system of claim 11 wherein the symbol comprises a diagram.

20. The electronic system of claim 11 wherein the electronic system comprises a video system and the electronic device comprises a video device.
